(19) United States
(12) Patent Application Publication
(10) Pub. No.: US 2003/0045664 A1
(43) Pub. Date: Mar. 6, 2003

(54) High ion conductive polymers, methods of producing, membrane formed therefrom and related compounds

(76) Inventors: Leong Ming Gan, Singapore (SG); Pei Yong Chow, Singapore (SG)

Correspondence Address: TRASK BRITT, P.O. BOX 2550, SALT LAKE CITY, UT, 84110, US

(21) Appl. No.: 10/176,958

(22) Filed: Jun. 21, 2002

(30) Foreign Application Priority Data
Jun. 25, 2001 (SG) 200103843-9

(51) Int. Cl. C08F 118/02

(52) U.S. Cl. 526/319; 526/915

(57) ABSTRACT

A method of producing a polymer, the method comprising copolymerizing a mixture comprising about 15% to 50% by weight of water; about 10% to 50% by weight of at least one copolymerizable surfactant; and about 5% to 40% by weight of at least one copolymerizable monomer; whereby the resultant polymer has aqueous domains having sizes smaller than 100 nm. Also disclosed is a polymer comprising domains containing at least one polar solvent, the domains having sizes smaller than 100 nm and the density of the domains being at least about 3*10³/μm³.

### BACKGROUND OF THE INVENTION

1. Field of the Invention

This invention relates to high ion conductive polymers and, in particular, to polymers suitable for the formation of proton-exchange membranes.

2. State of the Art

Ion conductive membranes find application in several fields of technology, for instance in the construction of proton-exchange fuel cells, and in sensors. However, conventional ion conductive membranes suffer from low ion conductivities, and currently available membranes display conductivities ranging from 10⁻² to 10⁻¹ Scm⁻¹. In general, it is desirable for the ion conductivities of such membranes to be as high as possible.

In addition, conventional ion conductive membranes are expensive and technically difficult to produce, leading to high costs for articles containing such membranes.

### BRIEF SUMMARY OF THE INVENTION

It is an object of the present invention to provide a polymer suitable for the formation of ion conductive membranes that alleviate at least some of the above drawbacks.

Accordingly, one aspect of the present invention provides a method of producing a polymer, the method comprising copolymerizing a mixture comprising about 15% to 50% by weight of water; about 10% to 50% by weight of at least one copolymerizable surfactant; and about 5% to 40% by weight of at least one copolymerizable monomer; whereby the resultant polymer has aqueous domains having sizes smaller than 100 nm.

Advantageously, the mixture comprises: about 20% to 25% by weight of water; about 20 to 40% by weight of the at least one copolymerizable surfactant; and about 10 to 35% by weight of the at least one copolymerizable monomer.

Preferably, the mixture further comprises about 0. 1% to 0.4% by weight of an initiator.

Conveniently, the initiator is a redox initiator or a photo-initiator.

Advantageously, the mixture is a microemulsion.

Preferably, the at least one copolymerizable monomer is ethylenically unsaturated.

Conveniently, the at least one copolymerizable surfactant comprises an ionic surfactant.

Advantageously, the ionic surfactant comprises a quaternary ionic group.

Preferably, the at least one copolymerizable surfactant comprises a zwitterionic surfactant.

Advantageously, the at least one copolymerizable surfactant comprises an ionic surfactant.

Preferably, the at least one copolymerizable surfactant comprises a non-ionic surfactant.

Conveniently, the non-ionic surfactant comprises a polyethylene oxide group containing from about 10 to about 110 polyethylene monomers.

Advantageously, the at least one copolymerizable surfactant is copolymerizable with the at least one copolymerizable monomer.

Another aspect of the present invention provides a compound having the structure: XSO₃(CH₂)ₘN(CH₂CH₂)₂N(CH₂)ₙV where 6≦n≦20, 1≦m≦10, X=Na⁺, Li⁺, or NH₄⁺, and V is (methyl)acrylate or another copolymerizable unsaturated group.

Preferably, the compound is a surfactant.

Conveniently, the compound is a monomer.

A further aspect of the present invention provides a polymer comprising domains containing at least one polar solvent, the domains having sizes smaller than 100 nm and the density of the domains being at least about 3*10³/μm³.

Advantageously, the density of the domains is in the range from about 3*10³/μm³ to about 3.5*10⁵/μm³.

Preferably, the polymer comprises: about 25% water; about 29% AUPSA; about 30% MMA; about 15% SPI and about 1% EGDMA.

Conveniently, the polymer has a conductivity of at least 0.5 Scm⁻¹.

Advantageously, at least some of the domains contain water.

Another aspect of the present invention provides membrane formed from a polymer according to the above.

### BRIEF DESCRIPTION OF THE SEVERAL VIEWS OF THE DRAWINGS

In order that the present invention may be more readily understood, embodiments thereof will now be described by way of example, in which:

FIG. 1 shows a typical ternary phase diagram of a monomer/surfactant/water mixture at 25° C.;

FIG. 2 shows a typical conductivity plot indicating an approximate composition region for bicontinuous microemulsions;

FIG. 3 shows a typical pore size distribution for a membrane formed from a polymer embodying the present invention; and

FIG. 4 gives details of the compositions and ion conductivities of five membranes formed from polymers embodying the present invention.

### DETAILED DESCRIPTION OF THE INVENTION

The ability of the present invention to provide high ion conductive polymers resides in the technique of copolymerizing mixtures comprising about 15% to 50% by weight of water, about 10% to 50% by weight of at least one copolymerizable surfactant and about 5% to 40% by weight of at least one copolymerizable monomer.

Preferably, microemulsions are employed as mixtures for use in methods embodying the present invention (precursor mixtures). A thermodynamically stable microemulsion is a transparent colloidal dispersion of oil and water, stabilized by a surfactant. Depending on the proportion of components and the hydrophile-lipophile value of surfactants used in a microemulsion, the formation of the microemulsion can be in the form of droplets which are swollen with oil but dispersed in water (normal or O/W microemulsion), or swollen with water but dispersed in oil (inverse or W/O microemulsion). In addition, bicontinuous microemulsions exist whose oil and aqueous domains are randomly interconnected to form sponge-like structures.

The above-described technique of polymerization of organic components in a mixture enables the synthesis of interconnected aqueous channels, which become pores when the finished polymer has been dried. These pores are randomly distributed in the resulting polymer, and when the polymer has been dried the pore sized distribution ranges from around 10 nm to 30 nm. The nature of these pores (i.e. closed cell or open cell) can be determined by the rate at which the resultant polymer is dried.

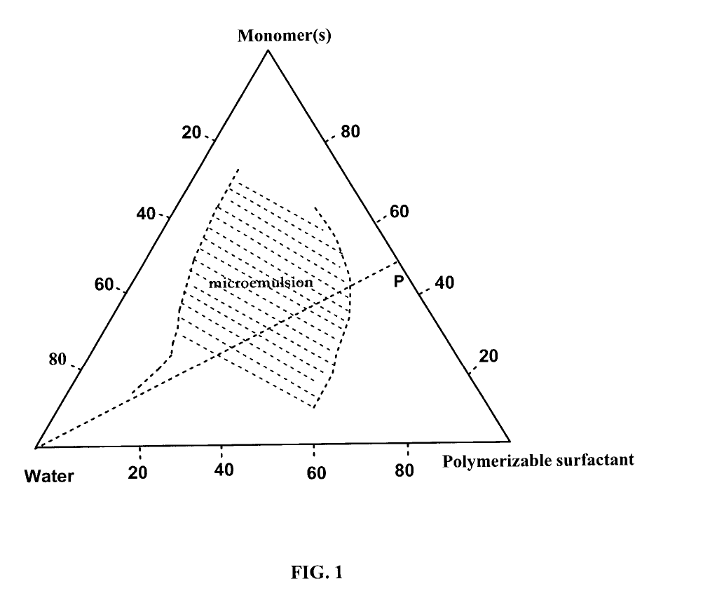

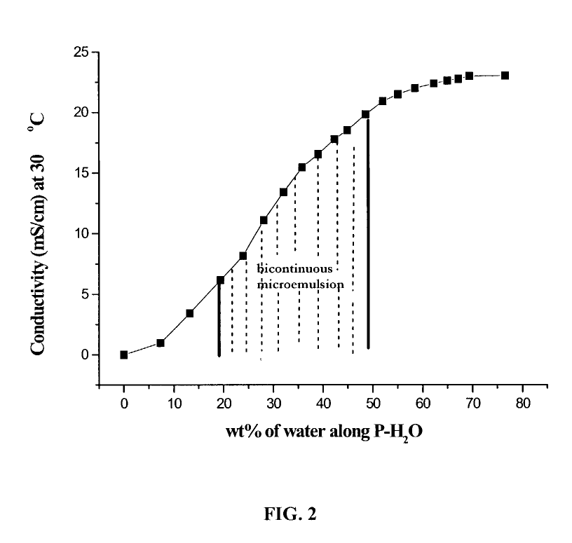

Turning to FIG. 1, a ternary phase diagram of a monomer/surfactant/water mixture at 25° C. is shown. The single-phase microemulsion region of the diagram is represented by a hatched area, and it is preferred to use mixtures falling within this hatched area in methods embodying the present invention. As can be seen from FIG. 2, the ionic conductivity of the mixture increases substantially in the bicontinuous microemulsion region.

The interconnected aqueous nanostructures in polymerized mixtures embodying the present invention arise from the rapid copolymerization of substantially all polymerizable organic components present in the precursor mixture. Such rapid copolymerization is initiated by either redox or photo-initiators at low temperatures, to ensure the nanostructural stability of the mixture during the copolymerization thereof.

In a preferred embodiment of the invention, the copolymerizable surfactant present in the precursor mixture is anionic, and may, for instance, have the structure:

CH₂=CR—CONR—CH₂(CH₂)ₙ—COOM

where M is either ammonium or a metal cation, R is either a hydrogen or an alkyl group selected from the group having 1, 2, 3, 4 or 5 carbon atoms, and where 6≦n≦20.

Alternatively, the copolymerizable surfactant may be anionic, and may have the structure:

XSO₃(CH₂)ₘN(CH₂CH₂)₂N(CH₂)ₙV

where 6≦n≦20, 1≦m≦10, X=Na⁺, Li⁺, or NH₄⁺, and V is (methyl)acrylate or another copolymerizable unsaturated group. This surfactant monomer, which contains a sulphonic acid group, is particularly advantageous in carrying out the present invention.

As a further alternative, the polymerizable surfactant may be non-ionic, and may, for instance, have the structure:

RO(CH₂CH₂O)ₓ—(CH₂)ₙV

where X is an integer ranging from about 10 to about 110, and where V is p-vinylbenzyl, (methyl)acrylate, or another copolymerizable unsaturated group.

It will be understood that suitable surfactants are not limited to those given above, and many other surfactants may be included in a precursor mixture for use in the method of the present invention.

Ethylenically unsaturated monomers that can be effectively employed in the method of the present invention include methyl methacrylate (MMA), acrylonitrile (AN), butyl acrylate (BA); ethylenically unsaturated monocarboxylic acids such as acrylic acid (AA) and methacrylic acid (MA); the C₁ to C₁₂ alkyl alcohol esters of acrylic as well as methacrylic acid; and other esters of the acids such as bis-3-sulphopropyl-itaconic acid ester (SPI) and glycidyl methacrylate (GMA); substituted methacrylates and acrylates such as 2-hydroxylethyl methacrylate (HEMA) and 2-hydroxylethyl acrylate; vinyl aryl monomers such as styrene and sodium or lithium styrene sulphonate, nitriles of ethylenically unsaturated carboxylic acids such as acrylonitrile and methacrylonitrile.

While ethylene glycol dimethacrylate (EGDMA) may be employed as a cross-linking agent in methods embodying the present invention, cross-linking agents such as diethylene glycol dimethacrylate, and diethylene glycol diacrylate are also effective.

As mentioned above, for low temperature (e.g. room temperature) polymerization, a photo-initiator, a redox-initiator or a mixture of both are preferably employed. Examples of effective photo-initiators include 2,2-dimethoxy-2-phenyl acetophenone (DMPA) and dibenzylketone. Examples of effective redox-initiators are ammonium persulphate and N,N,N′,N′-tetramethylethylene diamine (TMEDA).

In addition to the above, the water domains of the precursor mixture may optionally include various additives having specific properties. Such additives are selected for conferring a desired property on the resulting polymer, and include fillers, dyes, inorganic electrolytes and pH adjusters.

In carrying out the present invention, it is first necessary to form a precursor mixture by mixing the appropriate components. It is preferred to form a microemulsion and, with appropriate formulations, microemulsions form spontaneously upon mixing the components, with little need for vigorous stirring. However, the mixture may be stirred as much as is necessary to form an appropriate microemulsion.

The polymerization of the microemulsion may occur readily, however (as mentioned above) at room temperature photo-initiators, redox initiators or both are likely to be required. If relatively large samples of polymer are to be produced, several hours of continuous polymerization may be required to produce a sample of useful mechanical strength.

Since a major application of polymers embodying the present invention is in the formation of membranes, it is often desirable to form the resultant polymer into a thin sheet. This can be achieved, for instance, by sandwiching the mixture between two glass plates during polymerization, or by coating the mixture on other membranes such as papers, glass fibers or other polymer membranes.

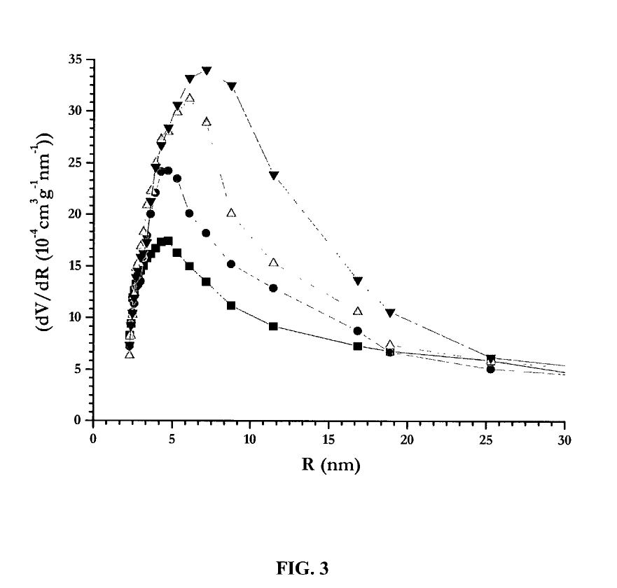

FIG. 3 shows typical pore size distributions for membranes fabricated using polymers produced by methods embodying the present invention. It will be seen that the vast majority of aqueous domains in the membranes have diameters in the region of 10 nm to 30 nm. However, the aqueous domains may have diameters of up to 100 nm.

The number of aqueous domains per unit volume of a polymer embodying the present invention will vary depending upon the size of the aqueous domains. However, in a preferred embodiment of the present invention, the density of aqueous domains is at least 3*10³/μm³, and may be as high as 3.5*10⁵/μm³.

The existence of numerous aqueous domains randomly distributed throughout polymers formed by methods embodying the present invention facilitates the transport of ions or protons through the polymers, and it will be appreciated that this feature gives the polymers high ion conductivities, thereby improving the performance of membranes comprising these polymers in Applications such as, for example, fuel cells.

The water in the domains can readily be removed by drying, and other polar solvents, such as ethylene carbonate or electrolyte solutions, can be introduced into the vacant domains. It will be appreciated that such polar solvents may confer beneficial properties on the resultant polymer, and the selection of the solvent to be introduced into the vacant domains will depend upon the intended application of the polymer.

In addition to the desirable performance of membranes embodying the present invention, the fact that the method of the present invention effectively involves only a single act (i.e. the co-polymerization of substantially all of the organic components in the precursor mixture) makes it possible to produce polymers very cheaply using methods embodying the present invention. Indeed, it has been found that membranes can be formed using methods embodying the present invention for around 5%-10% of the cost of producing conventional ion conductive membranes.

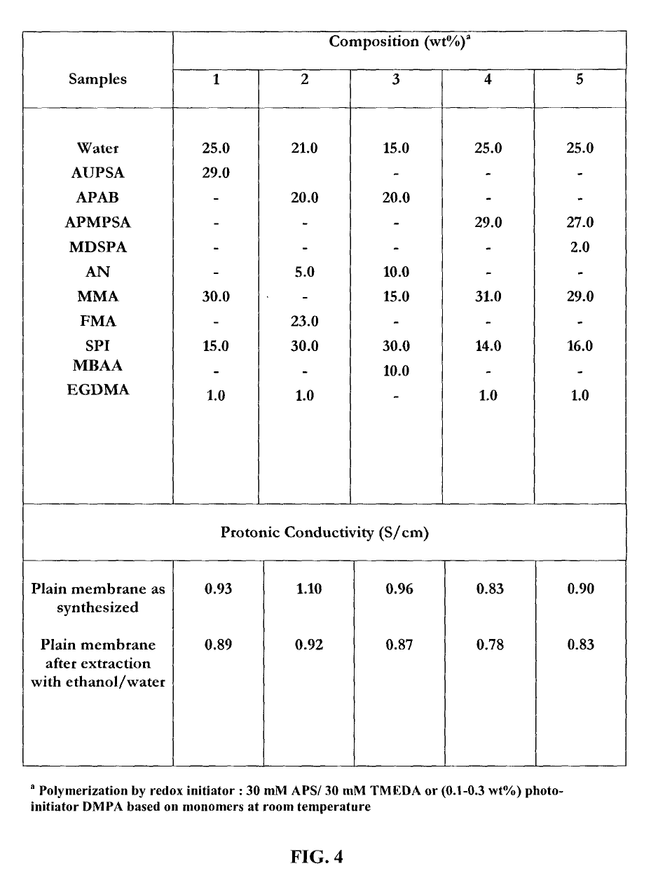

FIG. 4 shows tables which give the composition and protonic conductivity of 5 membranes, each of which were synthesized by methods embodying the present invention from bicontinuous microemulsions consisting of polymerizable surfactants, such as AUPSA XSO₃H(CH₂)ₘN(CH₂CH₂)₂N(CH₂)ₙCOOCH=CH₂) where 6≦n≦20, 1≦m≦10, X=Na⁺, Li⁺, or NH₄⁺, and V is (methyl)acrylate or another copolymerizable unsaturated group or APAB (CH₂=CHCOHN(CH₂CH₂)₂N⁺(CH₃)(CH₂)₁₆Br⁻), APMPSA (CH₂₌CH(CH₂)ₙ CONHCHCHCHCHN⁺CH₃(CH₂)ₘSO₃¹), monomers such as acrylonitrile (AN) and methyl methacrylate (MMA), 2,2,3,3-tetrafluoropropylmethacrylic acid ester (FMA), bis-3-sulphopropyl-itaconic acid ester (SPI) or [(2-methacryloyloxy)ethyl]-dimethyl(3-sulpho-propyl) ammonium hydroxide (MDSPA), and N′N methylene bis-acrylamide (MBBA) or ethylene glycol dimethacrylate (EGDMA) as a cross-linker.

The bicontinuous precursor microemulsions were simply polymerized or impregnated in glass-fiber sheet or filer paper before being subjected to polymerization at room temperature using either a UV photo-initiator (2,2-dimethoxy-2-phenyl acetophenone (DMPA) and dibenzylketone (DBK)) or a redox initiator comprising an equimolar mixture of ammonium persulphate (APS) and N,N,N′,N′-tetramethylethylene diamine (TMEDA). The membranes were subsequently treated with 0.5M H₂SO₄.

It will be understood from the table displayed in FIG. 4 that the protonic conductivities of the 5 membranes listed therein are substantially higher than those of currently available membranes. Indeed, membranes forming from polymers embodying the present invention can display protonic conductivities as high as one order of magnitude above those displayed by conventional membranes.

In summary, it will be appreciated that the present invention provides a method of producing polymers that may be used to form membranes displaying significant advantages over conventional membranes, including increased protonic conductivity and reduced cost.

While the present specification employs the term “comprises” in certain instances in identifying one of more constituents of certain elements and features without limitation as to the presence or absence of other constituents, the use of this term is not a disclaimer of elements and features consisting of only the recited constituents.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A method of producing a polymer, the method comprising:
copolymerizing a mixture comprising
about 15% to 50% by weight of water;
about 10% to 50% by weight of at least one copolymerizable surfactant; and
about 5% to 40% by weight of at least one copolymerizable monomer;
whereby the resultant polymer has aqueous domains having sizes smaller than 100 nm.

2. The method according to claim 1, further comprising formulating the mixture to comprise:
about 20% to 25% by weight of water;
about 20 to 40% by weight of the at least one copolymerizable surfactant; and
about 10 to 35% by weight of the at least one copolymerizable monomer.

3. The method according to claim 1, further comprising providing about 0.1% to 0.4% by weight of an initiator in the mixture.

4. The method according to claim 3, further comprising selecting the initiator to be at least one of a redox initiator and a photo-initiator.

5. The method according to claim 1, further comprising forming the mixture as a microemulsion.

6. The method according to claim 1, further comprising selecting the at least one copolymerizable monomer to be ethylenically unsaturated.

7. The method according to claim 1, further comprising selecting the at least one copolymerizable surfactant to comprise an ionic surfactant.

8. The method according to claim 7, further comprising selecting the ionic surfactant to comprise a quaternary ionic group.

9. The method according to claim 1, further comprising selecting the at least one copolymerizable surfactant to comprise a zwitterionic surfactant.

10. The method according to claim 1, further comprising selecting the at least one copolymerizable surfactant to comprise an anionic surfactant.

11. The method according to claim 1, further comprising selecting the at least one copolymerizable surfactant to comprise a non-ionic surfactant.

12. The method according to claim 11, further comprising selecting the non-ionic surfactant to comprise a polyethylene oxide group containing from about 10 to about 110 polyethylene monomers.

13. The method according to claim 1, further comprising formulating the at least one copolymerizable surfactant to be copolymerizable with the at least one copolymerizable monomer.

14. A compound having the structure
XSO₃H(CH₂)ₘN(CH₂CH₂)₂N(CH₂)ₙV
where 6≦n≦20, 1≦m≦10, X=Na⁺, Li⁺, or NH₄⁺, and V is (methyl)acrylate or another copolymerizable unsaturated group.

15. The compound according to claim 14, wherein the compound is a surfactant.

16. The compound according to claim 14, wherein the compound is a monomer.

17. A polymer comprising domains containing at least one polar solvent, the domains having sizes smaller than 100 nm and the density of the domains being at least about 3*10³/μm³.

18. The polymer according to claim 17, wherein the density of the domains is in the range from about 3*10³/μm³ to about 3.5*10⁵/μm³.

19. The polymer according to claim 17, comprising: about 25% water; about 29% AUPSA; about 30% MMA; about 15% SPI; and about 1% EGDMA.

20. The polymer according to claim 17, having a conductivity of at least 0.5 Scm⁻¹.

21. The polymer according to claim 18, wherein at least some of the domains contain water.

22. A membrane formed from a polymer, comprising:
domains containing at least one polar solvent, the domains having sizes smaller than 100 nm and the density of the domains being at least about 3*10³/μm³.

23. The membrane according to claim 22, wherein the density of the domains is in the range from about 3*10³/μm³ to about 3.5*10⁵/μm³.

24. The membrane according to claim 22, comprising about 25% water; about 29% AUPSA; about 30% MMA; about 15% SPI; and about 1% EGDMA.

25. A membrane according to claim 22 having a conductivity of at least 0.5 Scm⁻¹.

26. A membrane according to claim 22, wherein at least some of the domains contain water.
